(19) United States
(12) Patent Application Publication
(10) Pub. No.: US 2002/0098263 A1
(43) Pub. Date: Jul. 25, 2002

(54) Drinking carbonated water for the use of reducing high blood pressure and edema

(76) Inventor: Sam Bida, Ely, NV (US)

Correspondence Address: Sam Bida, 2160 Crawford Street, Ely, NV, 89301, US

(21) Appl. No.: 09/768,756

(22) Filed: Jan. 25, 2001

(51) Int. Cl. A01K 1/00; A23L 1/00

(52) U.S. Cl. 426/2

(57) ABSTRACT

By taking carbonated water orally each day it aids in the reduction of high blood pressure and edema. To use this invention a person would orally drink 5 oz. of the carbonated water in the morning and another 5 oz. in the evening for the reduction of high blood pressure and edema.

### BACKGROUND OF THE INVENTION

This invention pertains to home health remedy. Many prescription drugs are sold each year for the control of high blood pressure and edema. The drugs which are prescribed for these aliments have many unhealthy side effects. My invention entails a person who is plagued by either or both high blood pressure and edema to take along with any medication that they may be on in order to help with the reduction of both high blood pressure and edema.

### BRIEF SUMMARY OF THE INVENTION

By orally drinking the carbonated water daily, high blood pressure and edema is reduced. The advantage of this invention is that it may be taken along with any and all prescription and non-prescription medications while aiding in the reduction of high blood pressure and edema without the side effects caused by some prescription and non-prescription drugs.

### BRIEF DESCRIPTION OF THE SEVERAL VIEWS OF THE DRAWINGS

Not Applicable.

### DETAILED DESCRIPTION OF THE INVENTION

By the taking of 10 fl. oz. carbonated water orally each day, 5 fl. oz. in the morning and 5 fl. oz. in the evening, it aids in the reduction of high blood pressure and edema.

The carbonated water's ingredients include: carbonated water, sodium bicarbonate, sodium citrate, potassium sulfate, Desmodium phosphate, as indicated by the registered trademarks of Cadbury Beverages, Inc.

The carbonated water trademarked used and sold by the Cadbury Beverage, Inc., is done so for purposes other than the ones claimed in this invention.

To use this invention a person would orally drink 5 oz. of the carbonated water in the morning and another 5 oz. in the evening for the reduction of high blood pressure and edema.

1. What I claim as my invention is that by orally drinking the carbonated water everyday, twice a day, once in the morning and once in the evening, the carbonated water will reduce high blood pressure and edema.

2. By orally drinking the carbonated water everyday it will reduce high blood pressure and edema and there are no side effects.

3. The drinking of the carbonated water every day can be taken with any prescription or non prescription drugs without any effect.
